(19) United States
(12) Patent Application Publication
(10) Pub. No.: US 2019/0130682 A1
(43) Pub. Date: May 2, 2019

(54) CONTROL SYSTEM AND METHOD FOR A VEHICLE

(71) Applicant: DURA AUTOMOTIVE SYSTEMS, Bievres (FR)

(72) Inventor: Thomas Farges, Gometz Le Chatel (FR)

(21) Appl. No.: 16/096,334

(22) PCT Filed: May 2, 2016
(86) PCT No.: PCT/IB2016/000747

§ 371 Date: Oct. 25, 2018

(51) Int. Cl. G07C 9/00; B60R 25/24

(52) U.S. Cl. CPC G07C 9/00309; B60R 25/241; G07C 2009/00547; G07C 2209/63; B60R 25/245

(57) ABSTRACT

A control system for a vehicle, comprising: a central unit-configured to actuate several functions of the vehicle, including unlocking, locking and starting the vehicle; an antenna arrangement integrated to the vehicle; a personal electronic device; a first multi-directional signal transmitted from the antenna arrangement to the personal electronic device; and a second multi-directional signal transmitted from the personal electronic device to the antenna arrangement, in response to the first multi-directional signal; wherein the second multi-directional signal is processed by the control system to evaluate a position of the personal electronic device outside or inside the vehicle. If the personal electronic device is evaluated outside the vehicle, then unlocking the vehicle is authorized and starting the vehicle is forbidden. If the personal electronic device is evaluated inside the vehicle, then starting the vehicle is authorized. A method for controlling a vehicle is also disclosed.

### TECHNICAL FIELD

The disclosure concerns a control system for a vehicle, comprising a central unit configured to actuate several functions of the vehicle, including unlocking, locking and starting the vehicle. The disclosure also concerns a control method for a vehicle.

### BACKGROUND

Several systems and methods are known to provide access to a vehicle.

Classically, a vehicle comprises at least one door provided with a lock. The driver inserts a key into the lock to unlock the latter, open the door and enter the vehicle.

Alternately or additionally, a vehicle can be provided with an electronic lock actuated by an electronic key.

WO 2010 115 585 discloses an example of electronic keypad integrated to a trim component of the vehicle.

WO 2013 184 316 discloses an example of keyless entry system including a mobile device portable by the driver and an accessory located inside the vehicle.

WO 2015 168 459 discloses an example of keyless entry system including a NFC device and a keypad.

Nowadays, keyless entry systems frequently use radio-frequency (RF) communication.

As mentioned on the website “http://blog.bluetooth.com/proximity-and-rssi”, RX and RSSI (Received Signal Strength Indication) techniques can be used to measure a radio signal strength. Both RX and RSSI are indications of the power level being received by an antenna. The difference between RX and RSSI is that RX is measured in milliWatts (mW) or decibel-milliwatts (dBm), whereas RSSI is a signal strength percentage—the higher the RSSI number, the stronger the signal. Unlike RX, RSSI is a relative measurement that is mostly defined by each chip manufacturer. There is no standardized relationship of any particular physical parameter to the RSSI reading. For example, a first manufacturer could have an RSSI max value of 100 while a second manufacturer will return RSSI values anywhere from 0 to 127. However, on one specific chip, we could have a mapping of an RSSI value to a particular physical RX value. For some platforms, only RSSI data is available from the high level API.

The variation of a RSSI value can be noticed even on a fixed location or distance. One factor for the variation could be the hardware/radio platforms. For instance, on iOS devices where there aren't many different chipsets, the RSSI value could accurately reflect the relationship to the distance. The RSSI value from a first iPhone probably means the same strength value on a second iPhone. However, on Android devices where we have a large variation of devices and chipsets, the absolute value of RSSI won't help easily map to a location. The same RSSI value on two different Android phones with two different chipsets may mean two different signal strengths. However, the RSSI value could still be very helpful in the proximity applications if used to get the trend of the RSSI value change. That trend could give meaningful data.

Thus, we will avoid using the absolute value of the RSSI and use the trend instead. Based on the fluctuation of radio signals, we can get a fairly accurate result of the RSSI trending. We can easily know if the signal is getting stronger or weaker, therefore, we will know if we are moving towards or away from the source. Even better, if we understand the specific mapping between the RSSI and the location of the specific receiving device, we could have a fairly accurate estimate of the distance.

Because of the nature of RF communications, both RX and RSSI will be largely influenced by factors in the environment. When using the RSSI value, we notice that the value drifts in a range because of the environmental influence. To filter out the influence, we can design a sampling algorithm which gives you the Mode (the value that occurs most often) of the RSSI sample set in a certain period. That way, the data will closely reflect the actual signal strength and filter out the noise.

### SUMMARY

The aim of the disclosure is to provide an improved control system for a vehicle.

The disclosure concerns a control system for a vehicle, comprising: a central unit configured to actuate several functions of the vehicle, including unlocking the vehicle, locking the vehicle and starting the vehicle; an antenna arrangement integrated to the vehicle; a personal electronic device portable by an user of the vehicle; a first multi-directional signal transmitted from the antenna arrangement to the personal electronic device; and a second multi-directional signal transmitted from the personal electronic device to the antenna arrangement, in response to the first multi-directional signal.

The second multi-directional signal is processed by the control system to evaluate a position of the personal electronic device outside or inside the vehicle. If the position of the personal electronic device is evaluated outside the vehicle, then unlocking the vehicle is authorized and starting the vehicle is forbidden; whereas if the position of the personal electronic device is evaluated inside the vehicle, then starting the vehicle is authorized.

The passive entry function consisting in unlocking the openings of the vehicle, then the passive start function consisting in starting the engine of the vehicle, can be performed in a simple and efficient way.

These functions can be performed by using a standard electronic device, not specific to the vehicle. Within the frame of the invention, a smart key is considered as specific to the vehicle, while a smartphone is considered as standard.

According to an embodiment of the control system, the antenna arrangement defines a signal intensity mapping having various values. The second multi-directional signal has a variable signal intensity, which is calculated then compared to the signal intensity mapping by the control system. If the variable signal intensity is inferior to a signal intensity reference, then the position of the personal electronic device is evaluated outside the vehicle, so that unlocking the vehicle is authorized and starting the vehicle is forbidden; whereas if the variable signal intensity is superior or equal to the signal intensity reference, then the position of the personal electronic device is evaluated inside the vehicle, so that starting the vehicle is authorized.

According to a further embodiment of the control system, the antenna arrangement comprises different antennas integrated to the vehicle. The signal intensity mapping is defined depending on locations of the antennas. The second multi-directional signal has a distinct variable signal intensity for each of the antennas. The position of the personal electronic device is evaluated by triangulation.

According to further aspects of the disclosure which are advantageous but not compulsory, such a control system may incorporate one or several of the following features:

The control system only relates to passive functions of locking, unlocking the vehicle and starting the vehicle.

The antenna arrangement comprises a main antenna and at least one secondary antenna, and the first multi-directional signal is transmitted to the personal electronic device only by the main antenna.

The main antenna emits the first multi-directional signal at a predetermined frequency, then the control system is configured to activate the at least one secondary antenna for receiving the second multi-directional signal only after the second multi-directional signal has been received by the main antenna.

The second multi-directional signal is processed by the antenna arrangement.

The second multi-directional signal is received by the antenna arrangement, then processed by the central unit.

The personal electronic device is configured to communicate via Bluetooth standard, preferably Bluetooth Low Energy standard.

The personal electronic device is configured to communicate via NFC standard.

The antenna arrangement is configured to communicate via Bluetooth standard, preferably Bluetooth Low Energy standard.

The central unit is configured to communicate via NFC standard.

The antenna arrangement comprises a single antenna, which is configured to send the first multi-directional signal and receive the second multi-directional signal.

The antenna arrangement comprises different antennas.

The antenna arrangement comprises a main antenna configured to send the first multi-directional signal.

The antenna arrangement comprises at least one secondary antenna configured to receive the second multi-directional signal.

The main antenna is further configured to receive the second multi-directional signal.

The main antenna is configured only to send the first multi-directional signal.

The secondary antenna is configured only to receive the second multi-directional signal.

The signal intensity mapping is defined by giving a different importance to the different antennas.

The signal intensity mapping is defined by giving a same importance to the different antennas.

The antenna arrangement is mounted in a front compartment of the vehicle.

The vehicle is provided with a gearbox control device, and the antenna arrangement includes a antenna integrated to the gearbox control device.

The antenna arrangement includes at least one antenna mounted next to an inner face of an outer component of the vehicle, for example a front door.

The antenna arrangement includes at least one antenna integrated to a driver door of the vehicle.

The invention also concerns a control method for controlling a vehicle, comprising: a central unit configured to actuate several functions of the vehicle, including unlocking the vehicle and starting the vehicle; and an antenna arrangement integrated to the vehicle; a personal electronic device portable by an user of the vehicle. The control method includes the following steps:

a personal electronic device is carried near the vehicle by an user of the vehicle;

a first multi-directional signal is transmitted from the antenna arrangement to the personal electronic device; and

a second multi-directional signal is transmitted from the personal electronic device to the antenna arrangement, in response to the first multi-directional signal;

the at least one multi-directional signal is processed to evaluate a position of the personal electronic device outside or inside the vehicle; then either

unlocking the vehicle is authorized and forbidding starting the vehicle is forbidden if the position of the personal electronic device is evaluated outside the vehicle; or

starting the vehicle is authorized if the position of the personal electronic device is evaluated inside the vehicle.

According to a further embodiment, the control method comprises the following steps:

a signal intensity mapping having various values is defined relative to the antenna arrangement; then

a variable signal intensity of the second multi-directional signal is calculated then compared to the signal intensity mapping, in order to evaluate a position of the personal electronic device outside or inside the vehicle; then either

unlocking the vehicle is authorized and starting the vehicle is forbidden if the variable signal intensity is inferior to a signal intensity reference, the position of the personal electronic device being evaluated outside the vehicle; or

starting the vehicle is authorized if the variable signal intensity is superior or equal to the signal intensity reference, the position of the personal electronic device being evaluated inside the vehicle.

According to a further embodiment of the control method, the antenna arrangement comprises different antennas integrated to the vehicle. The signal intensity mapping is defined depending on locations of the antennas. The second multi-directional signal has a distinct signal intensity for each of the antennas. The position of the personal electronic device is evaluated by triangulation.

According to further aspects of the disclosure which are advantageous but not compulsory, such a control method may incorporate one or several of the following features:

The antenna arrangement comprises a main antenna and at least one secondary antenna, and the first multi-directional signal is transmitted to the personal electronic device only by the main antenna.

The second multi-directional signal is received from the personal electronic device by the main antenna and/or by the at least one secondary antenna.

The second multi-directional signal is received from the personal electronic device by the main antenna and by the at least one secondary antenna.

The main antenna emits the first multi-directional signal at a predetermined frequency, then the at least one secondary antenna is activated to receive the second multi-directional signal only after the second multi-directional signal has been received by the main antenna.

Unlocking the vehicle is automatically performed when the position of the personal electronic device is evaluated in a nearby area outside the vehicle.

Locking the vehicle is automatically performed when the position of the personal electronic device is evaluated moving from a nearby area outside the vehicle to a distant area outside the vehicle.

Starting the vehicle must be voluntarily performed by the user, for example by pushing a start button, when the position of the personal electronic device is evaluated inside the vehicle.

The personal electronic device is initially recognized by the vehicle via NFC communication.

The personal electronic device has a Bluetooth identifier transmitted to the vehicle during the NFC communication.

The first multi-directional signal is a Bluetooth signal, preferably a Bluetooth Low Energy signal.

The second multi-directional signal is a Bluetooth signal, preferably a Bluetooth Low Energy signal.

The second multi-directional signal is received and processed by the antenna arrangement.

The second multi-directional signal is received by the antenna arrangement, then processed by the central unit.

After processing the second multi-directional signal, then the functions of unlocking the vehicle, locking the vehicle or starting the vehicle are authorized via a Bluetooth communication between the vehicle and the personal electronic device.

The vehicle initiates the Bluetooth communication, preferably in a master to slave mode, more preferably with the vehicle as master and the personal electronic device as slave.

The Bluetooth communication is established directly between the personal electronic device and the central unit.

The Bluetooth communication is established directly between the antenna arrangement and the central unit.

The Bluetooth communication is established between the personal electronic device and the antenna arrangement, then a second communication is established between the antenna arrangement and the central unit.

### BRIEF DESCRIPTION OF THE DRAWINGS

Certain embodiments of the invention will now be explained in correspondence with the annexed figures, and as an illustrative example, without restricting the object of the invention. In the annexed figures:

FIG. 1 is an upper view of a control system, for a vehicle shown in horizontal section;

FIGS. 2 to 4 are views similar to FIG. 1, illustrating the control method; and

FIGS. 5 to 8 are views similar to FIG. 4, for control systems according to alternate embodiments of the invention.

### DETAILED DESCRIPTION

The disclosure will now be explained in correspondence with the annexed figures, and as an illustrative example, without restricting the object of the invention. In the annexed figures:

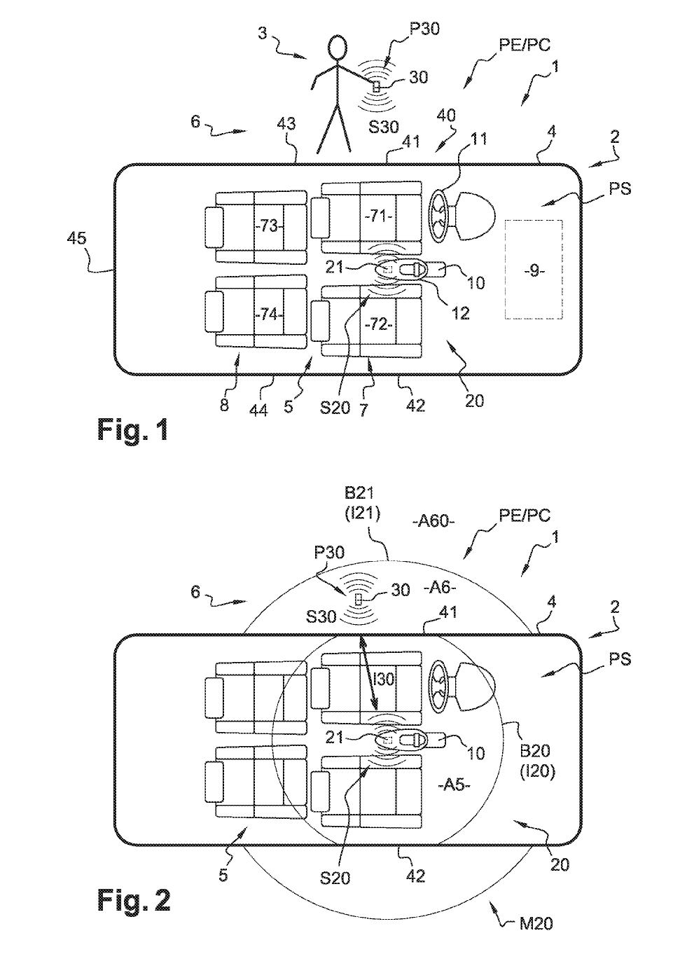

FIGS. 1 to 4 show a control system 1, equipping an automotive vehicle 2. Of course, vehicle 2 can have a different configuration without leaving the scope of the invention.

A user 3 is represented next to vehicle 2, only in FIG. 1 for simplification purpose. Generally, user 3 is the driver of vehicle 2.

Vehicle 2 comprises a body structure 4, delimiting an interior 5 and an exterior 6 of vehicle 2. Vehicle 2 comprises a front compartment 7 and a rear compartment 8. Under its front hood, vehicle 2 comprises an engine 9. In front compartment 7, vehicle 2 comprises a central unit 10, a steering wheel 11 and a gearbox control device 12.

Vehicle 2 comprises several openings 40 integrated to body structure 4 and providing access to interior 5 of vehicle 2. More precisely, vehicle 2 comprises front lateral doors 41 and 42, rear lateral doors 43 and 44, and a rear trunk door 45.

Front compartment 7 includes a driver seat 71 and a passenger seat 72. Rear compartment 8 includes passenger seats 73 and 74, which can be independent or form a single rear seat depending on configuration of vehicle 2.

Engine 9 may be a combustion engine or any other motorization system, for example an electric motorization or a hybrid motorization.

Central unit 10 is configured to actuate various functions of vehicle 2, including a passive entry function PE consisting in unlocking vehicle 2, a passive closure function PC consisting in locking the vehicle 2, and a passive start function PS consisting in starting vehicle 2. More precisely, the passive entry function PE consists in unlocking openings 40 of vehicle 2, to provide access to its interior 5. The passive closure function PC consists in locking openings 40 of vehicle 2, to prevent access to its interior 5. Besides, the passive start function PS consists in starting engine 9, so vehicle 2 can move. Central unit 10 includes an onboard computer and various sub-systems associated with the different functions of vehicle 2.

Vehicle 2 integrates an antenna arrangement 20. In the exemplary embodiment of FIGS. 1 to 4, antenna arrangement 20 includes a single antenna 21 mounted inside gearbox control device 12. Antenna 21 emits a multi-directional signal S20, preferably in Bluetooth Low Energy standard.

Antenna arrangement 20 is connected to central unit 10 via wired or wireless means. In a particular embodiment, antenna 21 is a sub-system of unit 10.

User 3 holds a personal electronic device 30, preferably a smartphone. Alternatively, device 30 may be a smart electronic watch, tablet or the like. Device 30 emits a multi-directional signal S30, which may be in Bluetooth Low Energy standard. Device 30 can also emit signals via other communication standards, such as LET, Wi-Fi and NFC.

Antenna 21 includes receiving and emitting means, so as to be able to emit signal S20 and receive signal S30. Likewise, device 30 includes receiving and emitting means, so as to be able to emit signal S30 and receive signal S20.

In a first embodiment, antenna 21 processes signal S30. In a second embodiment, central unit 10 processes signal S30 received by antenna 21.

According to at least one embodiment, control system 1 comprises central unit 10, antenna arrangement 20, device 30, signals S20 and S30.

In practice, signal S30 is processed by control system 1 to evaluate a position P30 of device 30 outside or inside vehicle 2. This processing operation can be continuous or regular, for example every one second.

If position P30 of device 30 is evaluated outside vehicle 2, then the passive entry function PE is authorized and the passive start function PS is forbidden by system 1. In other words, unlocking of openings 40 is authorized, while starting of engine 9 is forbidden. The unlocking of openings 40 is automatically performed when position P30 of device 30 is evaluated outside vehicle 2 close to body structure 4, more precisely close to driver door 41. After unlocking, said openings 40 must be voluntarily open by user 3. More precisely, the driver door 41 or another entry 42-45 of vehicle 2 must be voluntarily open by user 3.

If position P30 of the device 30 is evaluated inside vehicle 2, then the passive start function PS is authorized. In other words, starting of engine 9 is authorized. Advantageously, starting of engine 9 must be voluntarily performed by user 3, for example by pushing a start button, when position P30 of device 30 is evaluated inside vehicle 2. In case starting of engine 9 was automatically performed when device 30 is evaluated inside vehicle 2, fuel would be wasted if user 3 doesn't want to move vehicle 2 immediately.

If position P30 of device 30 is evaluated moving away outside vehicle 2, then the passive closure function PC is automatically performed by system 1. In other words, locking of openings 40 is automatically performed. After locking, passive entry function PE has to be performed to access vehicle 2.

In a further embodiment described here-after, the control method is based on RSSI (Received Signal Strength Indication). Alternatively to RSSI, the control method can be based on any other evaluation technique.

Antenna arrangement 20 defines a signal intensity mapping M20 around antenna 21. Mapping M20 consists in various signal intensity values distributed in space inside and outside vehicle 3. Those signal intensity values depend on distance from antenna 21. The closest from antenna 21, the strongest is the signal intensity.

Signal S30 between device 30 and antenna arrangement 20 has a variable signal intensity I30, which is calculated by control system 1 processing signal S30. Depending on the configuration of system 1, the variable signal intensity I30 can be calculated by control unit 10, or directly by antenna arrangement 20.

After control system 1 is configured, mapping M20 can include signal intensity references I20 and I21 having preset intensity values. In other words, signal intensity reference I20 corresponds to a predetermined distance from antenna 21 defining a border B20, while signal intensity reference I21 corresponds to another predetermined distance from antenna 21 defining a border B21. Signal intensity reference I20 is superior to signal intensity reference I21, so that distance defining border B20 is inferior to distance defining border B21.

Several areas are defined by antenna arrangement 20, around antenna 21. More precisely, an inside area A5 centered on antenna 21 is defined inside vehicle 2, a nearby area A6 is defined outside vehicle 2 but near body structure 4 of vehicle 2, and a distant area A60 is defined outside vehicle 2 farther than area A6.

In practice, borders B20 and B21 define areas A5, A6 and A60. Area A5 is defined closer to antenna 21 than border B20. Area A6 is defined between borders B20 and B21. Area A60 is defined farther from antenna 21 than border B21.

If the variable signal intensity I30 is inferior to the signal intensity reference I20, then position P30 of the personal electronic device 30 is evaluated inside area A6 or A60, anyway outside area A5. Thus, position P30 of device 30 is evaluated outside vehicle 2, so that the passive entry function PE is authorized and the passive start function PS is forbidden by system 1. Advantageously, unlocking of openings 40 is authorized then automatically performed when position P30 of device 30 is evaluated in nearby area A6 outside vehicle 2.

If the variable signal intensity I30 is superior or equal to the signal intensity reference I20, then position P30 of device 30 is evaluated inside area A5. Thus, position P30 of device 30 is evaluated inside vehicle 2, so that starting the passive start function PS is authorized by system 1.

If the variable signal intensity I30 is superior to the signal intensity reference I21, and becomes inferior to this signal intensity reference I21, then position P30 of device 30 is evaluated moving from nearby area A6 to distant area A60 outside vehicle 3. Thus, the passive closure function PC is automatically performed by system 1.

At this stage, we note on FIGS. 2 to 4 that area A5 does not cover the whole interior 5 of vehicle 2. Antenna 21 is arranged inside gearbox control device 12, such that area A5 covers the front compartment 7 of vehicle 2. If device 30 is located in the trunk or on a rear seat 73 or 74 of vehicle 2, its position P30 outside area A5 is estimated outside vehicle 2.

When device 30 is a smartphone, most of the time user 3 seated on driver seat 41 puts device 30 on passenger seat 42, in a side or central storage compartment, in his bag disposed on or in front of the passenger seat 42, or keep it in his jacket pocket. When device 30 is a watch, user 3 keeps it fixed to his wrist. In other words, user 3 usually keeps device 30 close to him in front compartment 7.

FIG. 2 shows system 1 when device 30 is located inside area A6, while openings 40 are closed. The passive entry function PE is authorized, so that openings 40 can be unlocked. Metal parts of body structure 4 forms a barrier for signals S20 and S30, such that their intensity drops when crossing body structure 4. In space, border B20 has a shape of a sphere truncated by body structure 4, more precisely by the roof and front doors 41 and 42 of vehicle 2.

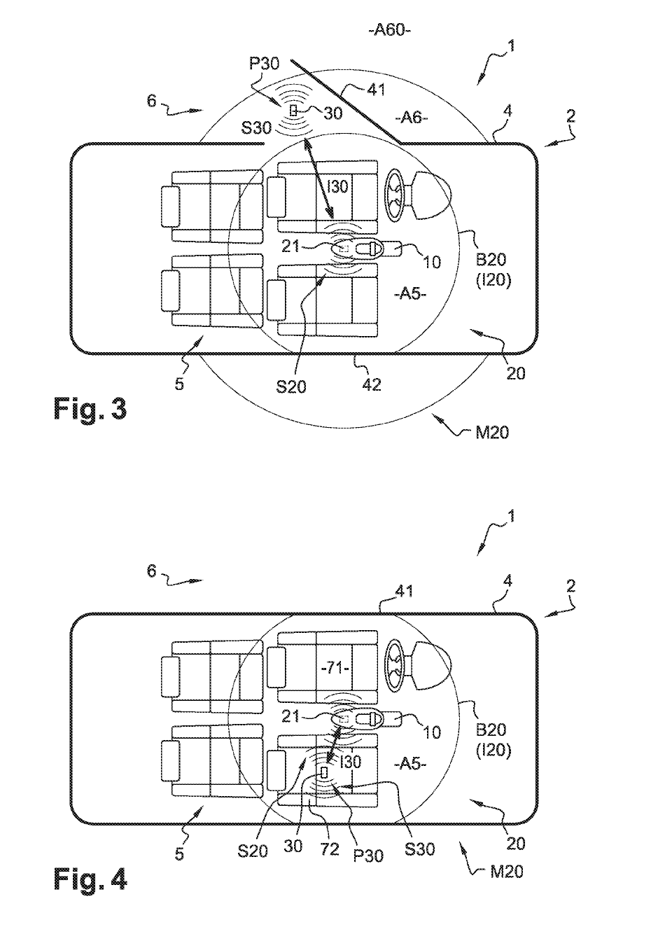

FIG. 3 shows system 1 when device 30 is located inside area A6, while driver door 41 is open. Border B20 extends outside vehicle 2, since signals S20 and 30 are not attenuated by closed door 41. Areas A5 and A6 are slightly modified. Antenna 21 is positioned and system 1 is configured such that area A5 does not overly extends outside vehicle 2.

FIG. 4 shows system 1 when device 30 is located inside area A5, on passenger seat 72, while door 41 is closed. The passive start function PS is authorized, so that engine 9 can be started.

Before control system 1 can be operated, device 30 must be recognized by vehicle 2 via NFC communication. When user 3 activates control system 1 for the first time, in order to access vehicle 3 via the passive entry function PE, device 30 initially provides an authentication key to vehicle 2 via said NFC communication.

According to various embodiments of control system 1, unlocking vehicle 2 via function PE, locking vehicle 2 via function PC or starting vehicle 2 via function PS can be authorized via:

Bluetooth communication established directly between device 30 and central unit 10;

Bluetooth communication established between device 30 and antenna arrangement 20, then a second communication (wired or wireless communication) established between antenna arrangement 20 and central unit 10.

Communications within system 1 are performed by using Bluetooth LE. Contrary to NFC communication, user 3 doesn't need to take device 30 out of his pocket every time he has to activate function PE, PC or PS.

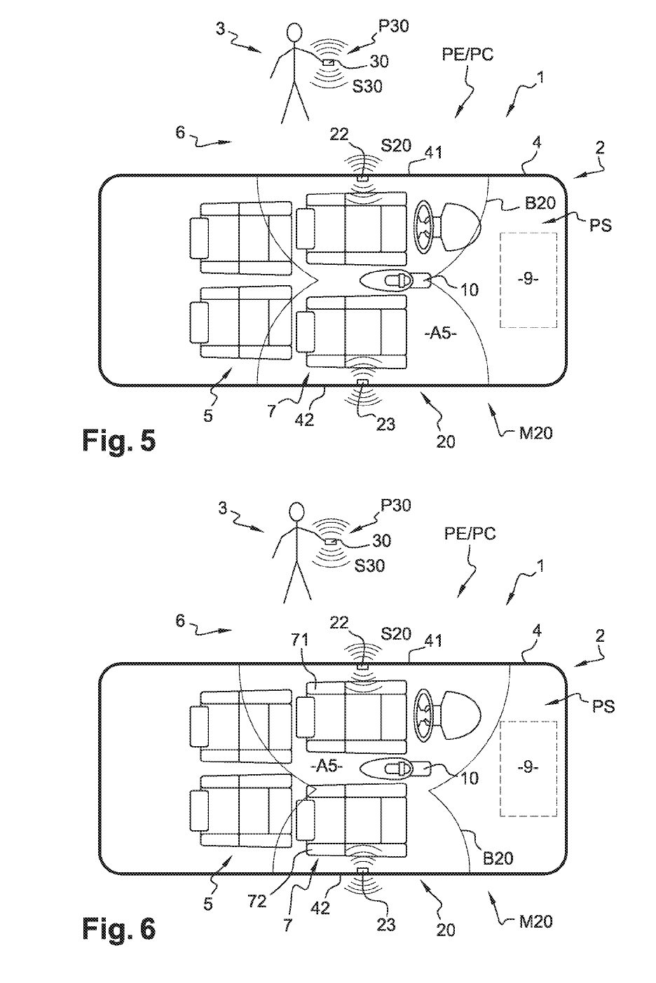

Other embodiments of the invention are represented on FIGS. 5 to 8. In those embodiments, elements similar to the first embodiment have the same references and work in the same way. Only the differences with respect to the first embodiment are described hereafter.

FIG. 5 shows an antenna arrangement 20 including a first antenna 22 integrated to driver door 41 and a second antenna 23 integrated to passenger door 42. Antennas 22 and 23 are mounted next to an inner face of doors 41 and 42, such that metal parts of said doors 41 and 42 are located between said antennas 22 and 23 and the exterior 6 of vehicle 2.

Antenna arrangement 20 defines a signal intensity mapping M20, borders B20 and B21, areas A5, A6 and A60 different from the first embodiment. Border B21, area A6 and area A60 are not shown for simplification purpose. Signal intensity mapping M20 is defined depending on locations of antennas 22 and 23. A same importance is given to each antenna 22 and 23, so that area A5 has a median plane of symmetry. As in the first embodiment, area A5 does not cover the whole interior 5 of vehicle 2, but covers the front compartment 7 of vehicle 2.

Antenna 22 is defined as the main antenna, while antenna 23 is defined as the secondary antenna. Antenna 22 is designed to emit signal S20, while antenna 23 is not designed to emit signal S20. Antenna 22 can be can be configured to receive or not receive signal S30. Antenna 23 is designed to receive signal S30. After reception, signal S30 is processed by system 1 to evaluate position P30 of device 30 outside or inside vehicle 2.

According to a further embodiment, both antennas 22 and 23 are designed to receive signal S30. Depending on the distance between device 30 and each of the antennas 22 and 23, signal S30 has a distinct signal intensity 130 for each of the antennas 22 and 23.

System 1 can be configured to activate antenna 22 to emit signal S20 at a predetermined frequency (for example every one second), then to activate antenna 23 briefly, only after signal S30 has been received by antenna 22. Therefore, position P30 of device 30 can be calculated by analyzing the distinct signal intensities 130 collected successively by the different antennas 22 and 23. In other words, position P30 of device 30 is evaluated by triangulation.

FIG. 6 shows an antenna arrangement 20 similar to FIG. 5, except signal intensity mapping M20 and signal intensity reference I20 are shifted by giving a different importance to each antenna 22 and 23. More precisely, a higher importance is given to antenna 22 integrated to driver door 41. Area A5 is not symmetric but more extended around the driver seat 71 than the passenger seat 72. As in the previous embodiments, area A5 does not cover the whole interior 5 of vehicle 2, but covers the front compartment 7 of vehicle.

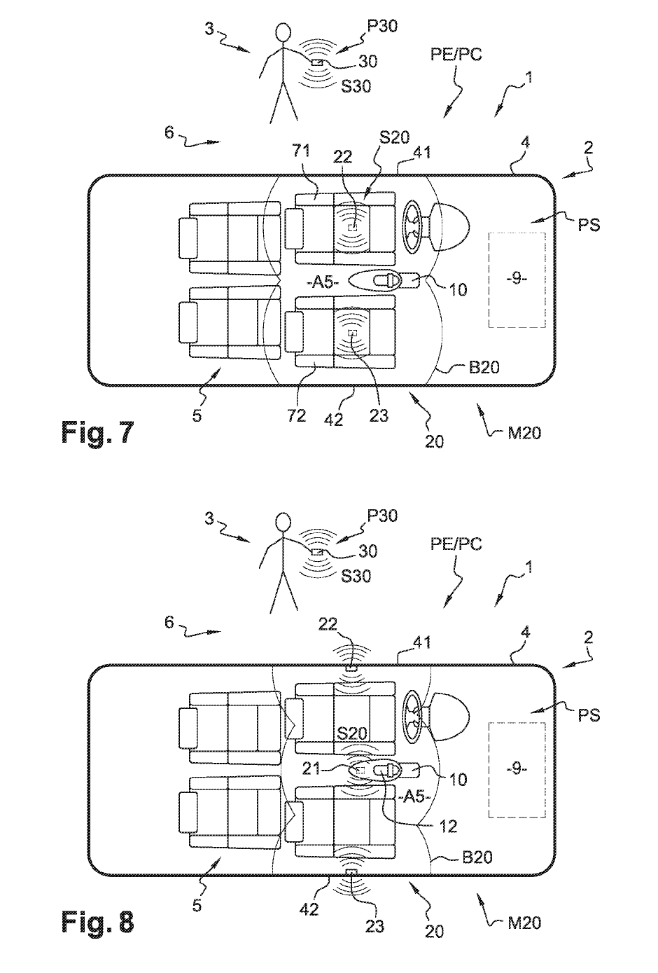

FIG. 7 shows an antenna arrangement 20 similar to FIG. 5, except antenna 22 is integrated to driver seat 71 and antenna 23 is integrated to passenger seat 72. As in the previous embodiments, area A5 does not cover the whole interior 5 of vehicle 2, but covers the front compartment 7 of vehicle 2.

FIG. 8 shows an antenna arrangement 20 combining the embodiments of FIGS. 1 to 5. Antenna 21 is integrated to gearbox control device 21, antenna 22 is integrated to driver door 41 and antenna 23 is integrated to passenger door 42. Optionally, signal intensity mapping M20 and signal intensity reference I20 may be shifted by giving a higher importance to antenna 21

Antenna 21 is defined as the main antenna, while antennas 22 and 23 are defined as the secondary antennas. Antenna 21 is designed to emit signal S20, while antennas 22 and 23 are not designed to emit signal S20. Antenna 21 can be configured to receive or not receive signal S30. Antennas 22 and 23 are designed to receive signal S30. After reception, signal S30 is processed by system 1 to evaluate position P30 of device 30 outside or inside vehicle 2.

According to a further embodiment, all antennas 21, 22 and 23 are designed to receive signal S30. Depending on the distance between device 30 and each of the antennas 21, 22 and 23, signal S30 has a distinct signal intensity 130 for each of the antennas 21, 22 and 23.

System 1 can be configured to activate antenna 21 to emit signal S20 at a predetermined frequency (for example every one second), then to activate antennas 22 and 23 briefly, only after signal S30 has been received by antenna 21. Therefore, position P30 of device 30 can be calculated by analyzing the distinct signal intensities 130 collected successively by the different antennas 21, 22 and 23. In other words, position P30 of device 30 is evaluated by triangulation.

Other non-shown embodiments can be implemented within the scope of the invention. For example, antenna arrangement 20 can comprise more than three antennas

In addition, technical features of the different embodiments can be, in whole or part, combined with each other. Thus, control system 1 and method can be adapted to the specific requirements of the application.

1. A control system for a vehicle, comprising:
a central unit configured to actuate several functions of the vehicle, including unlocking the vehicle, locking the vehicle and starting the vehicle;
an antenna arrangement integrated to the vehicle; and
a personal electronic device portable by an user of the vehicle;
a first multi-directional signal transmitted from the antenna arrangement to the personal electronic device; and
a second multi-directional signal transmitted from the personal electronic device to the antenna arrangement, in response to the first multi-directional signal;
wherein the second multi-directional signal is processed by the control system to evaluate a position of the personal electronic device outside or inside the vehicle; and
wherein if the position of the personal electronic device is evaluated outside the vehicle, then unlocking the vehicle is authorized and starting the vehicle is forbidden;
whereas if the position of the personal electronic device is evaluated inside the vehicle, then starting the vehicle is authorized.

2. The control system according to claim 1, wherein the antenna arrangement defines a signal intensity mapping having various values;
wherein the second multi-directional signal has a variable signal intensity, which is calculated then compared to the signal intensity mapping by the control system; and
wherein if the variable signal intensity is inferior to a signal intensity reference then the position the personal electronic device is evaluated outside the vehicle, so that unlocking the vehicle is authorized and starting the vehicle is forbidden;
whereas if the variable signal intensity is superior or equal to the signal intensity reference, then the position of the personal electronic device is evaluated inside the vehicle, so that starting the vehicle is authorized.

3. The control system according to claim 2, wherein the antenna arrangement comprises different antennas integrated to the vehicle, wherein the signal intensity mapping is defined depending on locations of the antennas, wherein the second multi-directional signal has a distinct variable signal intensity for each of the antennas, and wherein the position of the personal electronic device is evaluated by triangulation.

4. The control system according to claim 3, wherein the antenna arrangement comprises a main antenna and at least one secondary antenna, and wherein the first multi-directional signal is transmitted to the personal electronic device only by the main antenna.

5. The control system according to claim 4, wherein the main antenna emits the first multi-directional signal a predetermined frequency, then the control system is configured to activate the at least one secondary antenna only after the second multi-directional signal has been received by the main antenna.

6. The control system according to claim 3, wherein the signal intensity mapping is defined by giving different importance to the different antennas.

7. The control system according to claim 3, wherein the signal intensity mapping is defined by giving a same importance to the different antennas.

8. The control system according to claim 1, wherein the vehicle is provided with a gearbox control device, and wherein the antenna arrangement includes an antenna integrated to the gearbox control device.

9. The control system according to claim 1, wherein the antenna arrangement includes at least one antenna mounted next to inner face of an outer component of the vehicle, for example a front door.

10. The control system according to claim 1, wherein the antenna arrangement includes at least one antenna integrated to a driver door of the vehicle.

11. A control method for controlling a vehicle, comprising:
a central unit configured to actuate several functions of the vehicle, including unlocking the vehicle, locking the vehicle and starting the vehicle; and
an antenna arrangement integrated to the vehicle;
wherein the control method includes the following steps:
a personal electronic device is carried near the vehicle by an user of the vehicle;
a first multi-directional signal is transmitted from the antenna arrangement to the personal electronic device; and
a second multi-directional signal is transmitted from the personal electronic device to the antenna arrangement, in response to the first multi-directional signal;
the second multi-directional signal is processed to evaluate a position of the personal electronic device outside or inside the vehicle; then either
unlocking the vehicle is authorized and starting the vehicle is forbidden if the position of the personal electronic device is evaluated outside the vehicle; or
starting the vehicle is authorized if the position of the personal electronic device is evaluated inside the vehicle.

12. The control method according to claim 11, comprising the following steps:
a signal intensity mapping having various values is defined relative to the antenna arrangement; then either
a variable signal intensity of the second multi-directional signal is calculated then compared to the signal intensity mapping, in order to evaluate a position of the personal electronic device outside or inside the vehicle; then
unlocking the vehicle is authorized and starting the vehicle (PS) is forbidden if the variable signal intensity is inferior to a signal intensity reference, the position of the personal electronic device being evaluated outside the vehicle; or
starting the vehicle is authorized if the variable signal intensity is superior or equal to the signal intensity reference, the position of the personal electronic device being evaluated inside the vehicle.

13. The control method according to claim 12, wherein the antenna arrangement comprises different antennas integrated to the vehicle, wherein the signal intensity mapping is defined depending on locations of the antennas, wherein the second multi-directional signal has a distinct signal intensity for each of the antennas, and wherein the position of the personal electronic device is evaluated by triangulation.

14. The control method according to claim 11, wherein unlocking the vehicle is automatically performed when the position of the personal electronic device is evaluated in a nearby area outside the vehicle.

15. The control method according to claim 11, wherein locking the vehicle is automatically performed when the position of the personal electronic device is evaluated moving from a nearby area outside the vehicle to a distant area outside the vehicle.

16. The control method according to claim 11, wherein starting the vehicle must be voluntarily performed by the user, for example by pushing a start button, when the position of the personal electronic device is evaluated inside the vehicle.

17. The control method according to claim 11, wherein the personal electronic device is initially recognized by the vehicle via NFC communication.

18. The control method according to claim 17, wherein the personal electronic device has a Bluetooth identifier transmitted to the vehicle during the NFC communication.

19. The control method according to claim 11, wherein after processing the second multi-directional signal then the functions of unlocking the vehicle, locking the vehicle or starting the vehicle are authorized via a Bluetooth communication between the vehicle and the personal electronic device.

20. The control method according to claim 19, wherein the vehicle initiates the Bluetooth communication, preferably in a master to slave mode, more preferably with the vehicle as master and the personal electronic device as slave.
